(19) United States
(12) Patent Application Publication
(10) Pub. No.: US 2016/0311481 A1
(43) Pub. Date: Oct. 27, 2016

(54) TRACK ADJUSTING SYSTEM

(71) Applicant: Caterpillar Inc., Peoria, IL (US)

(72) Inventors: Marion B. Grant, Princeville, IL (US); Timothy A. Thorson, Morton, IL (US)

(73) Assignee: Caterpillar Inc., Peoria, IL (US)

(21) Appl. No.: 15/200,144

(22) Filed: Jul. 1, 2016

(51) Int. Cl. B62D 55/30

(52) U.S. Cl. CPC B62D 55/30; E02F 3/7604

(57) ABSTRACT

A track adjustment system for adjusting a track of an undercarriage system of a machine is provided. The undercarriage system includes a drive sprocket and an idler. The track adjustment system includes a sensor module provided proximate to a portion of the track. The sensor module generates a signal indicative of a sag in the portion of the track. An adjuster assembly is coupled to the idler, and adjusts a position of the idler with respect to the drive sprocket. A controller is coupled to the sensor module and the adjuster assembly. The controller receives the signal indicative of the sag in the portion of the track. The controller compares the sag with a pre-defined range. The controller alters a tension, through the adjuster assembly, in the portion of the track, if the sag in the portion of the track lies outside the pre-defined range.

### TECHNICAL FIELD

The present disclosure relates to an undercarriage system of a machine, and more specifically, to adjusting a track of the undercarriage system of the machine.

### BACKGROUND

Machines, such as track-type tractors etc. are used for performing various operations. Typically, the machines include an undercarriage assembly to propel the machine on a variety of different terrains, such as sand surfaces, mud surfaces, or any other uneven surfaces. The undercarriage assembly includes various components, such as tracks, drive sprockets, idlers, load rollers, and a track roller frame spring. During the operation of the machine, a portion of the track between the drive sprocket and the idler may sag. The sag may be defined as an under-tension condition or an over-tension condition in the tracks which results in reduced power transmission efficiency to propel the machine. Further, during the operation of the machine, track tension may vary due to an ingestion of soil/debris within the track (leading to tightening) and wear and tear of various components of the undercarriage assembly (leading to loosening). In case of tightening within the track, excessive loading of internal joints in the track may exist, and which in turn may lead to extra wear and tear to the track itself. On the other hand, in the case of loosening of the track, the track may easily de-rail from load rollers (causing excessive stresses in the track and frame, and leading to wear and tear in the track). Alternatively, the track may also jump the drive sprocket, leading to loud impact loads of joints that subsequently engage with the drive sprocket, which may lead to wear and tear of a drive sprocket tooth and/or a track joint.

Currently, a number of techniques are available to prevent the sag between the drive sprocket and the idler. For example, adjustments may be made to the tracks by adding grease to a track spring adjustment mechanism. Typically the undercarriage assembly is cleaned out on a periodic basis. This technique accounts for necessary adjustments due to wear, but effect on the track tension from the wear tends to be slow. Also, the adjustments may be required only on a weekly or a daily basis. Thus, such technique may not be effective at controlling tension as the track ingests material, which may require adjustments to be made very quickly (i.e., within minutes or less). In another example, adjustments may be made to the tracks by using a real-time pressure adjustment mechanism. The real-time pressure adjustment mechanism requires detecting small differences of large pressure measurements, and requires accurate and well-calibrated/filtered systems. As a result, such techniques may be expensive and may not provide a timely adjustment of the sag in the tracks.

U.S. Pat. No. 9,169,623 describes a wear monitoring system for a track type machine. The wear monitoring system includes at least a first radius sensor which is configured to generate a first signal indicative of a change in radius of at least one idler wheel. The wear monitoring system includes a displacement sensor which is configured to generate a second signal indicative of a change in displacement of a track tensioning actuator. The wear monitoring system includes a controller in communication with the first radius sensor and the displacement sensor. The controller is configured to determine wear of a track link guided by the at least one idler wheel and tensioned by the track tensioning actuator based on the first and second signals. Further, the wear monitoring system may make adjustments due to wear, but the effect on the track tension from the wear tends to be slow. Also, the adjustments may be required only on a weekly or a daily basis. However, such type of the wear monitoring system may not be effective at controlling tension as the track ingests material, which may require adjustments to be made very quickly (i.e., within minutes or less).

However, known solutions may not be efficient and cost effective in controlling the sag in the tracks of the machine. Therefore, there is a need for an improved track adjusting system provided in association with the machine.

### SUMMARY OF THE DISCLOSURE

in one aspect of the present disclosure, a track adjustment system for adjusting a track of an undercarriage system of a machine is provided. The undercarriage system includes a drive sprocket and an idler. The track adjustment system includes a sensor module provided proximate to a portion of the track. The sensor module is configured to generate a signal indicative of a sag in the portion of the track. An adjuster assembly is coupled to the idler. The adjuster assembly is configured to adjust a position of the idler with respect to the drive sprocket. A controller is coupled to the sensor module and the adjuster assembly. The controller is configured to receive the signal indicative of the sag in the portion of the track. The controller is configured to compare the sag in the portion of the track with a pre-defined range. The controller is configured to alter a tension, through the adjuster assembly, in the portion of the track, if the sag in the portion of the track lies outside the pre-defined range.

Other features and aspects of this disclosure will be apparent from the following description and the accompanying drawings.

### BRIEF DESCRIPTION OF THE DRAWINGS

FIG. 1 is a side view of an exemplary machine, in accordance with the concepts of the present disclosure;

FIG. 2 is a side view of an undercarriage system of the machine of FIG. 1 showing an under-tension condition in a portion of a track, in accordance with the concepts of the present disclosure; and

FIG. 3 is a side view of the undercarriage system of the machine of FIG. 1 showing an over-tension condition in the portion of the track, in accordance with the concepts of the present disclosure.

### DETAILED DESCRIPTION

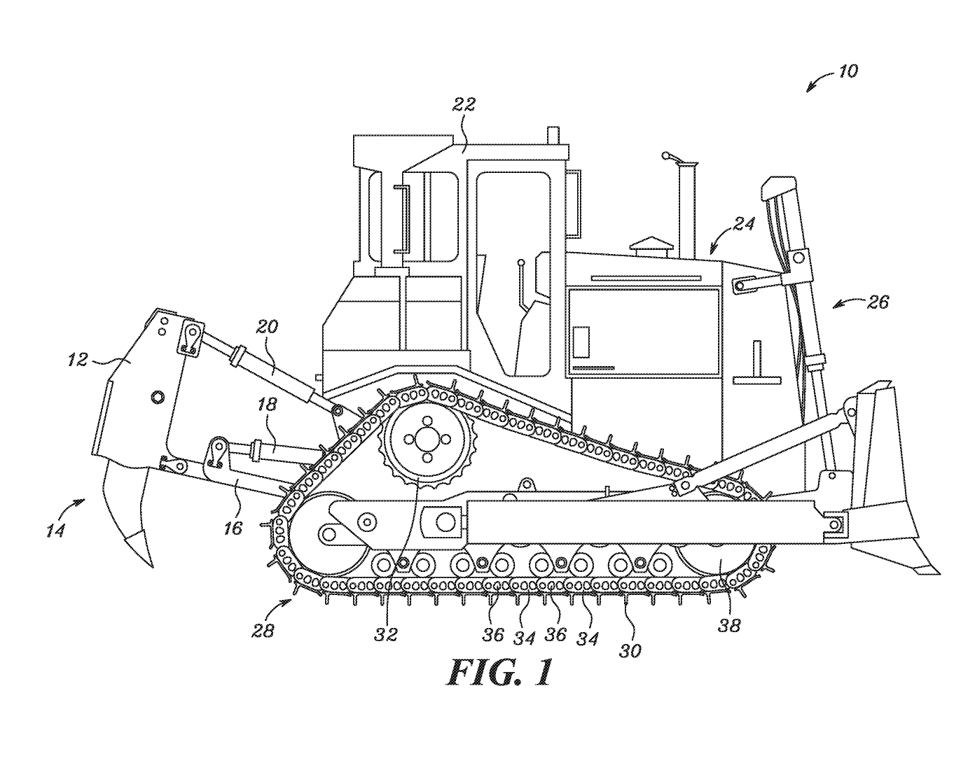

Referring to FIG. 1, an exemplary machine 10 is illustrated. The machine 10 includes a ripper tool 12 which is disposed at a first end 14 of the machine 10. The ripper tool 12 is utilized for ripping operations such as, but not limited to, to loosen hardened ground or break up rock formations. The ripper tool 12 is coupled to a ripper frame assembly 16. Further, the machine 10 includes a first hydraulic cylinder 18 which is coupled to the ripper frame assembly 16, and a second hydraulic cylinder 20 which is coupled to the ripper tool 12.

The machine 10 further includes an operator cab 22 and an engine assembly 24. The engine assembly 24 is disposed at a second end 26 of the machine 10 and includes an engine (not shown) which is configured to provide power to the machine 10. Further, the machine 10 includes an undercarriage system 28. The undercarriage system 28 includes a track 30 that is driven by the engine via a drive sprocket 32. The track 30 includes a number of links 34 connected end-to-end via pins 36. The track 30 is wrapped around the drive sprocket 32 and an idler 38. In the accompanying figures, only the single track 30 and the single drive sprocket 32 have been illustrated for exemplary purposes, without departing from the scope of the present disclosure. The design of the undercarriage system 28 may vary and is not limited to that described herein. The machine 10 may further include various other components that are not labeled in FIG. 1 for the purpose of simplicity. It will be apparent to one skilled in the art that the machine 10 shown in FIG. 1 is a track-type tractor. However, the machine 10 may be any other tracked machine such as, but not limited to, a track-type loader, tanks, pipelayers, pavers, underground mining equipment, electric rope shovels, hydraulic mining shovels and an excavator, without departing from the scope of the disclosure. It should be noted that an adjustable track system is valuable to the excavators and the hydraulic mining shovels, given that while digging, a tighter track 30 provides a more stable platform for the machine 10. Therefore, the adjustable track system may loosen the track 30 while travelling to reduce wear of the track 30, and thereafter tighten the track 30 once the machine 10 stops to increase stability of the machine 10.

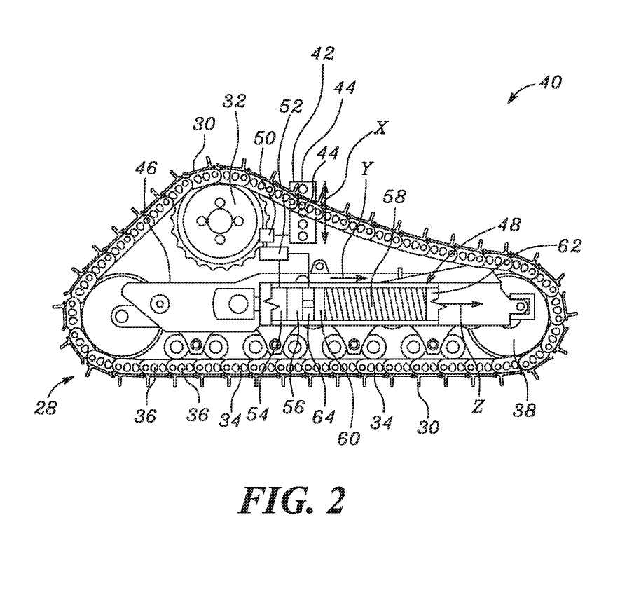

Referring to FIG. 2, a track adjustment system 40 includes a sensor module 42 which is provided proximate to a portion of the track 30. In an embodiment, the track adjustment system 40 may also include a number of sensor modules 42 which are positioned at corresponding locations proximate to the track 30. The sensor module 42 is configured to generate a signal indicative of a sag in the portion of the track 30. When the drive sprocket 32 drives the track 30, torque applied by the drive sprocket 32 causes the sag in the portion of the track 30, especially in a condition when thrust resistance increases. This portion of the track 30 may include the links 34 of the track 30 that lie between the drive sprocket 32 and the idler 38 such that the portion of the track 30 is not in contact with a work surface of the machine 10. The term “sag” used herein refers to an under-tension condition or an over-tension condition in the portion of the track 30. The sag may be quantified in terms of a value or a number which may indicate any one of the under-tension condition in the portion of the track 30, the over-tension condition in the portion of the track 30, or an acceptable tension condition in the portion of the track 30.

The sensor module 42 includes a number of sensors 44 such that the sensor module 42 is configured to generate a signal indicative of a presence of the portion of the track 30 in front of the respective sensor 44. It should be noted that the sensor module 42 includes a linear arrangement of the number of sensors 44, such as, but are not limited to, proximity sensors, sag sensors, displacement sensors, eddy current sensors, and paramagnetic sensors positioned such that the sensor module 42 is positioned perpendicular to a horizontal frame member 46 of the undercarriage system 28. Alternatively, the sensor module 42 includes a single sensor configured to generate a signal indicative of a distance of the portion of the track 30 from the sensor module 42. The sensor module 42 may be the single sensor which is disposed vertically along a direction X and perpendicular to the horizontal frame member 46. It should be noted that in another embodiment, the sensor module 42 may be disposed parallel along a length of the portion of the track 30 either above the track 30 or below the track 30, without departing from the scope of the disclosure.

If the sensor module 42 detects deviation in the portion of the track 30 from a pre-defined position of the track 30 between the drive sprocket 32 and the idler 38, then the sensor module 42 generates the signal indicative of the sag in the portion of the track 30. The pre-defined path may be a theoretical straight line path that the track 30 traverses while the machine 10 is moving, or a curved path that allows for an acceptable sag in the track 30. It should be noted that more than one sensor module 42 may be provided at different locations between the drive sprocket 32 and the idler 38. It will be apparent to one skilled in the art that the sensors 44 in the sensor module 42 mentioned above have been provided only for explanation purposes, without departing from the scope of the disclosure.

The track adjustment system 40 further includes an adjuster assembly 48 which is coupled to the idler 38. The adjuster assembly 48 is configured to adjust a position of the idler 38 with respect to the drive sprocket 32. The detailed description of the adjuster assembly 48 is described later in this section. Further, the track adjustment system 40 includes a controller 50 which is coupled to the sensor module 42 and the adjuster assembly 48. The controller 50 is configured to receive the signal indicative of the sag in the portion of the track 30, from the sensor module 42. After receiving the signal indicative of the sag in the portion of the track 30, the controller 50 is configured to compare the sag in the portion of the track 30 with a pre-defined range. In an embodiment, the pre-defined range may be indicative of an acceptable value of the sag in the portion of the track 30. The pre-defined range may be determined based on a historical data, may be obtained from reports, external source or repository associated with the machine 10, without departing from the scope of the disclosure.

Based on the comparison, the controller 50 determines whether the sag in the portion of the track 30 lies within the pre-defined range or outside the pre-defined range. It should be noted that if the sag in the portion of the track 30 lies outside the pre-defined range, then the controller 50 is configured to alter a tension in the portion of the track 30 through the adjuster assembly 48. If the portion of the track 30 lies outside the pre-defined range, the portion of the track 30 may either be subject to the under-tension condition or the over-tension condition. Referring to FIG. 2, during the under-tension condition in the portion of the track 30, the sag in the portion of the track 30 is more than the pre-defined range. Alternatively, the under-tension condition may occur, if the sag in the portion of the track 30 is less than the pre-defined range, without departing from the scope of the disclosure.

As an example, if the pre-defined range is 2-5 units, and the sag in the portion of the track 30 has a value of 6 units, then the portion of the track 30 is identified as undergoing the under-tension condition. If the portion of the track 30 is experiencing the under-tension condition, the portion of the track 30 may fall closer towards the horizontal frame member 46 as compared to an acceptable position thereof. The controller 50 is configured to provide a notification of the sag in the portion of the track 30. An output device, i.e. a display, or a meter may depict the current sag in the track 30. In one embodiment, the operator of the machine 10 may manually control the sag by activating the track adjustment system 40 in case of a tight/loose track 30. The operator may operate a tension increase button or a tension decrease button to incrementally and manually control the sag in the track 30. In order to adjust the tension in the portion of the track 30, the controller 50 sends a signal for actuating a valve 52. The valve 52 may be a 1-way electric/hydraulic valve or a 2-way electric/hydraulic valve. The valve 52 is actuated in a way that allows fluid to pass to a first chamber 54 of the adjuster assembly 48. Further, the adjuster assembly 48 includes a hydraulic piston 56 and a track roller frame spring 58. The hydraulic piston 56 may be a 1-way hydraulic piston, or a 2-way hydraulic piston. It should be noted that an increase in pressure of the fluid in the first chamber 54 of the adjuster assembly 48 pushes the hydraulic piston 56 in a first direction Y. The hydraulic piston 56 then pushes a first piston 60 which in turn pushes the track roller frame spring 58. The track roller frame spring 58 then pushes a second piston 62 for pushing the idler 38 along a second direction Z, thus adjusting the tension in the portion of the track 30. The second direction Z is parallel to the first direction Y.

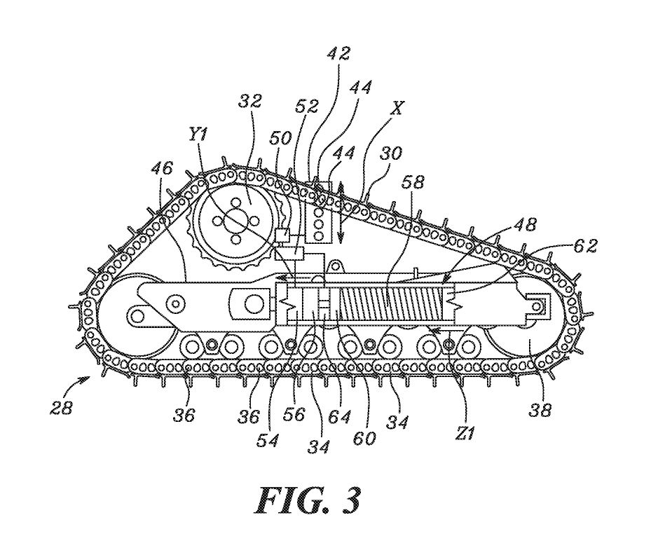

In another scenario, the portion of the track 30 may experience the over-tension condition. Referring to FIG. 3, the undercarriage system 28 of the machine 10 subject to the over-tension condition in the portion of the track 30 is illustrated. If the portion of the track 30 is experiencing the over-tension condition, the portion of the track 30 moves away from the horizontal frame member 46 as compared to the acceptable position thereof. Accordingly, during the over-tension condition in the portion of the track 30, the sag in the portion of the track 30 may have a value which is less than the pre-defined range. As an example, if the pre-defined range is 2-5 units and the sag in the portion of the track 30 is 1 unit, then the over-tension condition in the portion of the track 30 may be identified by the controller 50. Alternatively, the over-tension condition may occur, if the sag in the portion of the track 30 is more than the pre-defined range, without departing from the scope of the disclosure.

Further, in order to adjust the tension in the portion of the track 30, the controller 50 sends a signal for actuating the valve 52. The valve 52 is actuated in away that allows fluid to pass to a second chamber 64 of the adjuster assembly 48. It should be noted that increase in pressure of the fluid in the second chamber 64 pushes the hydraulic piston 56 in a third direction Y1. Further, the hydraulic piston 56 pulls the first piston 60 which then pulls the track roller frame spring 58. The track roller frame spring 58 then pulls the second piston 62 for pulling the idler 38 along a fourth direction Z1, for adjusting, the tension in the portion of the track 30. The third direction is parallel to the fourth direction Z1.

It should be noted that the controller 50 mentioned above may embody a single microprocessor or multiple microprocessors. Numerous commercially available microprocessors can be configured to perform the functions of the controller 50. It should be appreciated that the controller 50 could readily be embodied in a general machine microprocessor capable of controlling numerous machine 10 functions. The controller 50 may include a memory, a secondary storage device, a processor, and any other components for running an application. Various other circuits may be associated with the controller 50 such as power supply circuitry, signal conditioning circuitry, solenoid driver circuitry, and other types of circuitry. It will be apparent to one skilled in the art that controlling movement of the idler 38 for adjusting the tension in the portion of the track 30 mentioned above has been provided only for explanation purposes. The components and the methodology through which the tension in the portion of the track 30 is altered by the adjuster assembly 48 may vary from that described herein.

### INDUSTRIAL APPLICABILITY

The present disclosure provides the track adjustment system 40 for dynamically adjusting the tension in the portion of the track 30 of the undercarriage system 28 of the machine 10. The track adjustment system 40 is a track tensioning adjustment system having a simplified construction. The truck adjustment system 40 identifies any of the under-tension condition and the over-tension condition in the portion of the track 30. Accordingly, the track adjustment system 40 adjusts the tension in the portion of the track 30 by controlling movement of the idler 38. Thus, the track adjustment system 40 provides a real-time feedback control for dynamically altering the tension in the portion of the track 30.

Further, the track adjustment system 40 may reduce or prevent abrupt jerks and slowdown of the machine 10 caused by excess or less tension in the track 30. Further, the track adjustment system 40 prevents wear and tear of various components of the undercarriage system 28 and the track 30. Also, the track adjustment system 40 is an efficient, a cost-effective, and accurate solution for adjusting the tension in the track 30 of the undercarriage system 28 of the machine 10.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A track adjustment system for adjusting a track of an undercarriage system of a machine, the undercarriage system including a drive sprocket and an idler, the track adjustment system comprising:
a sensor module provided proximate to a portion of the track, the sensor module configured to generate a signal indicative of a sag in the portion of the track;
an adjuster assembly coupled to the idler, the adjuster assembly configured to adjust a position of the idler with respect to the drive sprocket; and
a controller coupled to the sensor module and the adjuster assembly, the controller configured to:
receive the signal indicative of the sag in the portion of the track; compare the sag in the portion of the track with a pre-defined range; and
alter a tension, through the adjuster assembly, in the portion of the track, if the sag in the portion of the track lies outside the pre-defined range.

2. The track adjustment system of claim 1, wherein the sensor module includes a plurality of sensors such that the sensor module is configured to generate a signal indicative of a presence of the portion of the track in front of the respective sensor.

3. The track adjustment system of claim 1, wherein the sensor module includes a single sensor configured to generate a signal indicative of a distance of the portion of the track from the sensor module.

4. The track adjustment system of claim 1, wherein the sensor module is positioned along a length of the portion of the track.

5. The track adjustment system of claim 1, wherein the sensor module is positioned perpendicular to a horizontal frame member of the undercarriage system.

6. The track adjustment system of claim 1, wherein the controller is further configured to provide a notification of the sag in the portion of the track.

7. The track adjustment system of claim 1, wherein a plurality of the sensor modules are positioned at corresponding locations proximate to the track.
